(19) United States
(12) Patent Application Publication
(10) Pub. No.: US 2009/0286006 A1
(43) Pub. Date: Nov. 19, 2009

(54) INK AND METHOD OF FORMING ELECTRICAL TRACES USING THE SAME

(75) Inventors: CHENG-HSIEN LIN, Tayuan (TW); QIU-YUE ZHANG, Shenzhen City (CN); YAO-WEN BAI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: FUKUI PRECISION COMPONENT (SHENZHEN) CO., LTD., Shenzhen City (CN); FOXCONN ADVANCED TECHNOLOGY INC., Tayuan (TW)

(21) Appl. No.: 12/327,621

(22) Filed: Dec. 3, 2008

(30) Foreign Application Priority Data
May 13, 2008 (CN) 200810301553.5

(51) Int. Cl. C09D 11/00; B05D 3/06

(52) U.S. Cl. 427/553; 106/31.13; 427/532

(57) ABSTRACT

An exemplary ink for forming electrical traces includes an aqueous carrier medium, a palladium salt and a reducing agent. The palladium salt is capable of being dissolved in the aqueous carrier medium. The reducing agent is configured for reducing the palladium ions into palladium particles under an irradiation ray.

### CROSS-REFERENCE TO RELATED APPLICATIONS

This application is related to commonly-assigned copending applications Ser. No. 12/235,994, entitled “METHOD OF FORMING CIRCUITS ON CIRCUIT BOARD”, and U.S. Ser. No. 12/253,869, entitled “PRINTED CIRCUIT BOARD AND METHOD FOR MANUFACTURING SAME”. Disclosures of the above-identified application are incorporated herein by reference.

### BACKGROUND

1. Technical Field

The present disclosure relates generally to an ink, and particularly, to an ink containing palladium ions and a method of forming electrical traces using the ink.

2. Description of Related Art

A method for forming circuits (or electrical traces) on a substrate using ink jet printing is becoming more and more popular, for example, for making printed circuit boards and semiconductor applications. Ink jet printing is a non-impact dot-matrix printing process in which droplets of ink are jetted from a small aperture directly to a specified area of a medium to create an image thereon.

A conventional ink jet printing method for manufacturing circuits is disclosed, in which an ink containing nano-scale metal particles and a disperser is applied by an ink jet printer onto a surface of a substrate to form a nano-scale metal particles pattern. The nano-scale metal particles pattern is then heat-treated (such as sintered) at a temperature of about 200 to 300 degrees Celsius. In such a manner, the disperser covering the nano-scale metal particles is removed, and then the nano-scale metal particles are meanwhile molten to form a continuous electrical trace with good conductive. However, in the heat treatment process, the high temperature (e.g. 200 to 300 degrees Celsius) can soften and melt the substrate due to a poor heat-resistant of the substrate, thereby, distorting the substrate. Therefore, the ink containing nano-scale metal particles is not suitable for ink jet circuits printing process.

What is needed, therefore, is an ink and a method of forming electrical traces by use of the ink which can overcome the above-described problems.

### SUMMARY

An exemplary ink for forming electrical traces includes an aqueous carrier medium, a palladium salt and a reducing agent. The palladium salt is soluble in the aqueous carrier medium. The reducing agent is configured for reducing palladium ions into palladium particles using an irradiation ray.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a flowchart of a method for forming electrical traces on a substrate, according to an exemplary embodiment.

FIG. 2 to FIG. 5 are schematic, cross-sectional views showing each step of the method described in FIG. 1.

### DETAILED DESCRIPTION OF THE EMBODIMENTS

Reference will now be made to the drawings to describe an exemplary embodiment of a ink and the method of forming electrical traces using the ink in detail.

An exemplary embodiment of a ink suitable for forming electrical traces generally includes an aqueous carrier medium, and a reducing agent and a palladium salt uniformly soluble in the aqueous carrier medium.

The palladium salt can be selected from the group consisting of palladium sulfate, palladium chloride, palladium nitrate and palladium-based complexe such as Pd(OAc)₂, and a concentration thereof may be in a range from 10⁻⁴ to 1 mol/L.

The reducing agent can be selected from the group consisting of sodium citrate and potassium sodium tartrate, and a concentration thereof is in a range from 10⁻³ to 0.4 mol/L. The reducing agent can be in a molar ratio of 10:1 to 200:1 to the palladium salt. It is understood that the palladium salt and the reducing agent may be chosen by composition and concentration according to practical needs, and are not limited as prescribed above. In this embodiment, the ink includes a palladium chloride and a sodium citrate.

The aqueous carrier medium optionally includes water or a mixture of water and at least one water soluble organic solvent. For example, water-soluble organic solvents may be selected from the group consisting of (1) alcohols, such as methyl alcohol, ethyl alcohol, n-propyl alcohol, iso-propyl alcohol, n-butyl alcohol, sec-butyl alcohol, t-butyl alcohol, iso-butyl alcohol, furfuryl alcohol, and tetrahydrofurfuryl alcohol; (2) ketones or ketoalcohols such as acetone, methyl ethyl ketone and diacetone alcohol; (3) ethers, such as tetrahydrofuran and dioxane; (4) esters, such as ethyl lactate; (5) polyhydric alcohols, such as ethylene glycol, diethylene glycol, triethylene glycol, propylene glycol, tetraethylene glycol, polyethylene glycol, glycerol, 2-methyl-2,4-pentanediol 1,2,6-hexanetriol and thiodiglycol; (6) lower alkyl mono- or di-ethers derived from alkylene glycols, such as ethylene glycol mono-methyl (or -ethyl)ether, diethylene glycol mono-methyl (or -ethyl)ether, propylene glycol mono-methyl (or -ethyl)ether, triethylene glycol mono-methyl (or -ethyl)ether and diethylene glycol di-methyl (or -ethyl)ether; (7) nitrogen containing cyclic compounds, such as pyrrolidone, N-methyl-2-pyrrolidone, and 1,3-dimethyl-2-imidazolidinone; and (8) sulfur-containing compounds such as dimethyl sulfoxide and tetramethylene sulfone.

Additionally, to improve a bonding strength between the ink and a substrate, a surface-active agent, a viscosity modifier, a binder, a humectant or mixtures thereof can be selectively added into the ink to adjust viscosity, surface tension, and stability of the ink. The surface-active agent can be anionic, cationic or non-ionic surface-active agent. The binder material can be polyurethane, polyvinyl alcohol or macromolecule polymer.

In the case, the aqueous carrier medium in the ink usually contains ethylene glycol in an amount of less than or equal about 50 weight percent. A content of the binder in the ink is in a range from 0.1 to 20 weight percent, a content of the viscosity modifier in the ink is in a range from 0.1 to 50 weight percent, a content of the surface-active agent in the ink is in a range from 0.1 to 5 weight percent. Percents are based on the total weight of the ink.

Irradiated under a irradiation ray having predetermined wavelength, an oxidation-reduction reaction between the reducing agent and the palladium salt will occur in the ink, and finally, the palladium salt are reduced to palladium metal particles. It is known that an oxidizability of palladium salt in the ink is relatively weak, so the reducing agent with different reducibility would determine the type of irradiation ray having an especial (low or high) energy corresponding to the reducibility of the reducing agent, for irradiating the ink and obtaining the palladium metal particles through the oxidation-reduction reaction of the reducing agent and the dissolvable palladium salt in the ink. That is, to activate the oxidation-reduction reaction between the reducing agent and the palladium salt, the weaker the reducibility of the reducing agent is, the higher energy of the irradiation ray used to irradiate the ink is required. In other words, the stronger the reducibility of the reducing agent is, the lower energy of the irradiation ray is required.

In summary, a reaction rate of the oxidation-reduction reaction is in negative proportion to the wave length of the irradiation rays and in positive proportion to the reducibility of the reducing agent. Thus, the ink with weaker reducing agent has a longer life time and the ink including the stronger reducing agent has a higher reaction rate. To avoid deterioration of the ink, it is better to preserve the ink in a dark environment.

Compared with the nano-scale metal particles, the palladium ions in the ink have an excellent dispersive ability, which can efficiently prevent aggregation of the nano-scale metal particles. Therefore, the palladium ions are uniformly dissolved for achieving the electrical traces with uniform thickness and width.

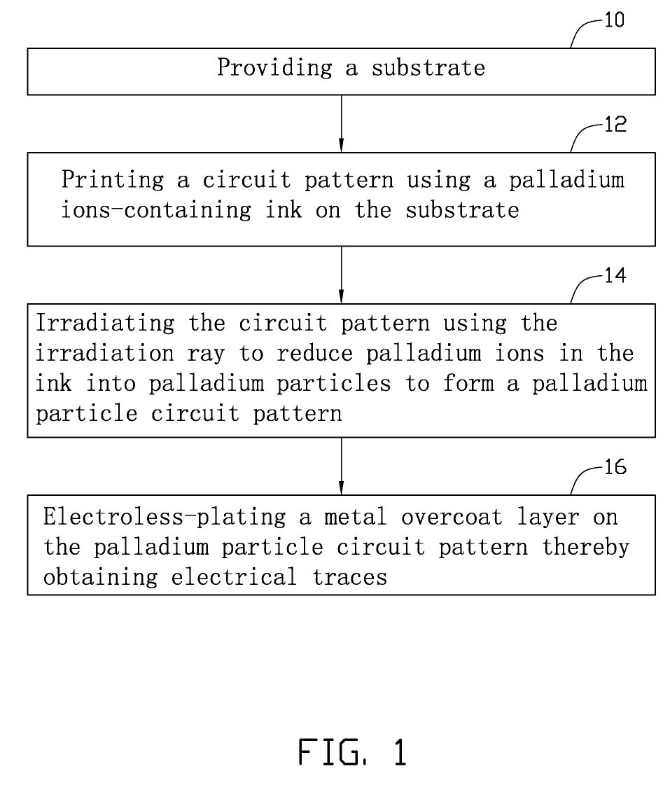

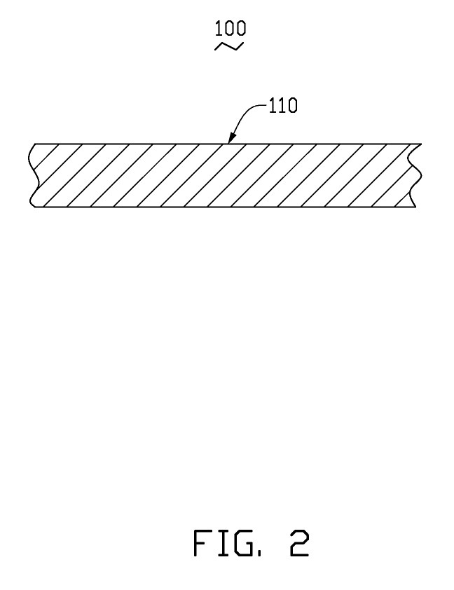

Referring to FIG. 1, an exemplary embodiment of a method of forming electrical traces on a substrate using the ink is illustrated. The method will be described in detail with reference to FIG. 2 to FIG. 5.

In step 10 referring to FIG. 2, a substrate 100 is provided. The substrate 100 is comprised of a material suitable for making printed circuit board, such as polyimide (PI), polyethylene terephthalate (PET), polyarylene ether nitrile (PEN), etc. The substrate 100 has a surface 110. To improve an bonding force between the circuit pattern 200 and the surface 110 of the substrate 100, the surface 110 can be processed using a surface treating processes, e.g., a cleaning process, a micro-etching process, to remove pollutants, oil, grease, or other contaminates from the surface 110 of the substrate 100.

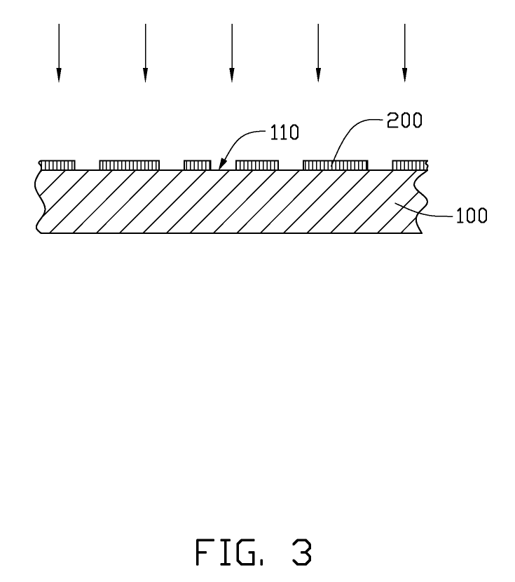

In step 12, referring to FIG. 3, a circuit pattern 200 made of the palladium ions-containing ink is formed on a substrate 100. The circuit pattern 200 is formed on the surface 110 using an ink jet printing method. In an ink jet printing process, an ink jet printer is used to form the circuit pattern 200 using the palladium ions-containing ink of the present embodiment, which includes the dissolvable palladium salt and the reducing agent. In the process of forming the circuit pattern 200, a nozzle of the ink jet printer is disposed close to the surface 110, and the ink is ejected from the nozzle and deposited on the surface 110 to form a desired pattern, i.e., the circuit pattern 200. The circuit pattern 200 is formed by the ink containing the palladium ions. This is, the circuit pattern 200 is brought into substantial coincidence with a trace formed by the ink. As mentioned above, the palladium ions are uniformly dissolved in the ink. Thus, the circuit pattern 200 has a uniform thickness and width on the surface 110.

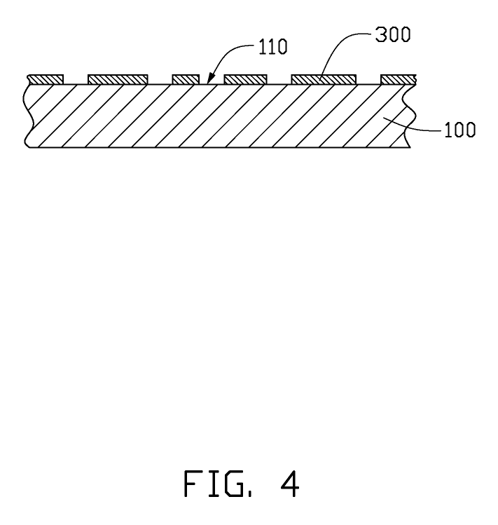

Continuing to step 14, referring to FIGS. 3 and 4, a irradiation ray irradiates the circuit pattern 200 for reducing the palladium ions in the ink into palladium particles, thus the circuit pattern 200 is converted or transformed into a palladium particle circuit pattern 300 comprised of the palladium particles, as shown in FIG. 4. The irradiation ray can be chosen from any high energy ray such as an ultraviolet ray, laser and γ radiation. The irradiating time is generally from about 1 minute to about 12 minutes to shorten a manufacturing circle time of the palladium particle circuit pattern 300. In addition, the types of irradiation ray and the irradiating time can vary according to types of the reducing agent employed.

In the present embodiment, the circuit pattern 200 is formed by the ink comprising the palladium chloride and the sodium citrate with a weak reducibility. Therefore, an ultraviolet irradiation ray having a high energy is provided to irradiate the substrate 100 with the circuit pattern 200, thereby reducing the palladium ions of the palladium chloride into the palladium particles. As a result, the palladium particles is aligned with a trace of the ink, i.e., the circuit pattern 200, and the substrate 100 with the circuit pattern 200 is dried at 65 degrees Celsius, for evaporating other liquid solvents of the ink (i.e. the aqueous carrier medium) and remaining the solid palladium particles to form the palladium particle circuit pattern 300 (i.e., a trace of the palladium particles). An average particle size of the palladium particles measured by scanning electron microscope (SEM) is about in a range from about 60 nanometers to 300 nanometers. The nano-scale palladium particles can achieve a more uniform distribution of the palladium particles on the surface 110, and then the palladium particle circuit pattern 300 has a uniform width and thickness thereby. It is reasonable that particle size of the palladium particles is unlimited and can be in any scale, such as nano-scale or micro-scale.

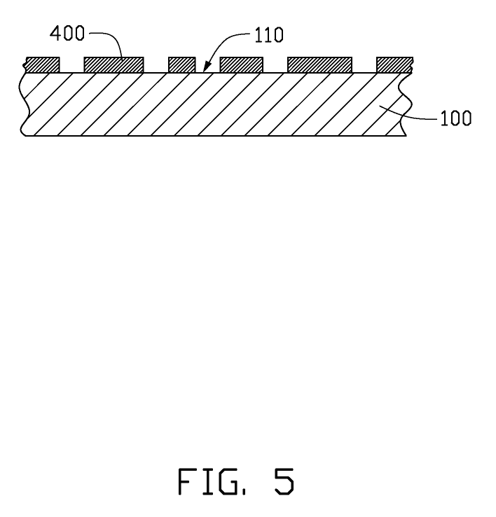

In step 16, a metal overcoat layer is plated on the palladium particle circuit pattern 300 to form a number of electrical traces 400 using an electroless-plating method, as shown in FIG. 5. Generally, the palladium particle circuit pattern 300 comprised of a number of palladium particles has a low electrical conductivity due to its incompact structure. Thus, a metal overcoat layer is further plated on the palladium particle circuit pattern 300 to improve electrical conductivity of the electrical traces 400.

In a plating process for the electrical traces 400, each of the palladium particles in the palladium particle circuit pattern 300 is a reaction center, and the metal encapsulates each of the palladium particles. Spaces between adjacent palladium particles are entirely filled with the metal. Therefore, the palladium particles of the palladium particle circuit pattern 300 are electrically connected to each other by the metal, thereby improving the electrical conductivity of the electrical traces 400.

In the present embodiment, the metal overcoat layer is copper overcoat layer and is formed by an electroless-plating method on the palladium particle circuit pattern 300. In detail, the palladium particle circuit pattern 300 is dipped into an electroless-plating solution comprising a plurality of copper ions at 50 degrees Celsius for 2 minutes. Copper particles are deposited in the spaces between adjacent palladium particles thereby forming the electrical traces 400, in which the palladium particles are electrically connected to each with the copper particles. Average particle size of the copper particles is in a range from about 50 nanometers to about 150 nanometers.

Moreover, the electroless-plating solution may further include other materials, such as a copper compound, a reducing agent and a complex agent. The copper compound may be copper sulfate, copper chloride and other copper ion-containing compounds. The reducing agent may be methanol or glyoxylic acid. The complex agent may be potassium sodium tartrate or ethylene diamine tetraacetic acid disodium salt. The electroless-plating solution can also include a stabilizing agent, a surface-active agent and a brightening agent therein for meeting practical electroless-plating requirement. The electroless-plating solution of the present embodiment includes 10 g/L of copper sulfate, 22 g/L of potassium sodium tartrate, 50 g/L of ethylene diamine tetraacetic acid disodium salt, 15 mL/L of formaldehyde and 10 mL/L of methanol. A term “g/L” is used herein to refer to a mass percentage of a solute (i.e. the copper sulfate, the potassium sodium tartrate and the ethylene diamine tetraacetic acid disodium salt) based on a total volume of the electroless-plating solution. Similarly, a term “mL/L” is applied herein to refer to volume percentage of a solvent (i.e. the formaldehyde and the methanol) based on a total volume of the electroless-plating solution.

To illustrate a influence of components of the ink (e.g. containing the sodium citrate and the palladium chloride) and an irradiation time of the irradiation ray to the palladium particle circuit pattern 300 and the electrical traces 400, the microstructure and electrical conductivity of the palladium particle circuit pattern 300 and the electrical traces 400 made from different inks containing different components are tested and researched. The test and research results will be further explained as following paragraphs. In the present embodiment, square resistance of the electrical traces 400 is measured using a four-point probe method. The square resistance represents a resistance between opposite edges of a square film (in ohms per square, Ω/□).

To evaluate influence of a proportion between the palladium chloride and sodium citrate on properties of both the palladium particle circuit pattern 300 and the electrical traces 400, four inks with the different mixing proportions between palladium chloride and sodium citrate are employed to prepare four palladium particle circuit patterns 300 and four electrical traces 400 under the same condition, for instance, irradiating time, plating-copper time. Average palladium particles size of each of four palladium particle circuit patterns 300, and average copper particles size and square resistance of each of four electrical traces 400 are measured and listed in Table 1.

TABLE 1

| | | palladium | | |
|---|---|---|---|---|
| ink | | particle circuit | electrical | |
| ratio of sodium | | pattern 300 | traces 400 | |
| citrate to | ethylene | palladium | copper | square |
| palladium | glycol (weight | particles size | particles | resistance |
| chloride | percent) | (nm) | size (nm) | (Ω/□) |
| 20:1 | — | 200 to 300 | — | — |
| 40:1 | — | | 60 to 150 | 0.330 |
| 40:1 | 20 | | 50 to 100 | 0.319 |
| 80:1 | — | | 50 to 100 | 6.892 |

According to Table 1, the average particle size of the copper particles decreases with increasing of ratio of sodium citrate to palladium chloride (from 20:1 to 40:1), whilst the square resistance of the electrical traces 400 decrease with increasing of ratio of sodium citrate to palladium chloride. It is known that a reaction chance of palladium ions with sodium citrate is in positive proportion to a concentration of sodium citrate, thus, the more sodium citrate; the more palladium ions are reduced to palladium particles. In the plating process, the palladium particles act as reaction center for depositing copper particles. Hence, particle size of the copper particles will be decreased when there are more palladium particles. As a result, the electrical traces 400 formed as above described can obtain a higher distribution density of the copper and palladium particles therein, and then improve electro-conductivity thereof.

However, when a ratio of sodium citrate to palladium chloride is as high as 80:1, the average particle size of the copper particles is fixed, whilst the square resistance of the electrical traces 400 increases. It is known that reaction chance of palladium ions with sodium citrate will reach to maximum at a special concentration of sodium citrate, thus, a remained portion of sodium citrate exceeding the special concentration will encapsulate the palladium particles thereby reducing reaction centers for an electroless-plating process, but dose not react with the palladium particles.

In contrast, when a ratio of sodium citrate to palladium chloride is lower to 20:1, the average particle size of the copper particles and the square resistance is not listed in Table 1 because of the results thereof non-correctly tested. The palladium ions are spaced from each other and eventually form thin and discontinuous trace on the surface 110 because of the small amount of the palladium ions in proportion to the total sodium. Therefore, the copper particles plated on the palladium particles are relatively small in scale and quantity, and fail to connect adjacent palladium particles in electroless-plating process. Correspondingly, the electrical traces 400 are not capable of achieving high electrical conductivity. The average particle size of the copper particles and the square resistance can't be correctly tested.

To evaluate influence of irradiating time on properties of both the palladium particle circuit pattern 300 and the electrical traces 400, two inks with the same mixing proportions between palladium chloride and sodium citrate are employed to prepare two palladium particle circuit patterns 300 and four electrical traces 400. Average palladium particles size of either palladium particle circuit pattern 300, and average copper particles size and square resistance of either electrical traces 400 are measured and listed in the Table 2.

TABLE 2

| irradiating time | palladium particle | | |
|---|---|---|---|
| using | circuit pattern 300 | electrical traces 400 | |
| ultraviolet | palladium particles | copper particles | square resistance |
| (minute) | size (nm) | size (nm) | (Ω/□) |
| 6 | 200 to 300 | 50 to 100 | 0.319 |
| 12 | 60 to 70 | | 0.882 |

As shown in Table 2, the average particle size of the palladium particles decrease, but the average particle size of the copper particles size is nearly invariable with increasing irradiating time, whilst the square resistance of the electrical traces 400 slightly increases with increasing irradiating time. It is known that a reaction time of palladium ions with the sodium citrate is positive proportion to an irradiating time using ultraviolet, thus, the palladium ions of the sodium citrate will be reduced to the palladium particles with smaller particle size.

It is understood based on the above illustration that, a component of the ink and the irradiation condition properly chosen is helpful in following ways, for instance, efficiently forming the palladium particles of the palladium particle circuit pattern 300 and a continuous and conductive electrical traces 400.

The surface 110 of the substrate 100 forming the electrical traces 400 is applied to manufacture electrical device, for example, printed circuit boards and semiconductor application. The method of the present embodiment provides a combination of chemical reaction and plating methods, instead of a high temperature sintering to connect nano-scale metal particles with each other. Therefore, the method improves continuity and electro-conductivity of electrical traces 400, and avoids the difficulty of controlling temperature during a sintering process.

While certain embodiments have been described and exemplified above, various other embodiments from the foregoing disclosure will be apparent to those skilled in the art. The present invention is not limited to the particular embodiments described and exemplified but is capable of considerable variation and modification without departure from the scope of the appended claims.

What is claimed is:

1. An ink for forming electrical traces, comprising:
an aqueous carrier medium;
a palladium salt soluble in the aqueous carrier medium; and
a reducing agent for reducing palladium ions into palladium particles using an irradiation ray.

2. The ink as claimed in claim 1, wherein the reducing agent is selected from the group consisting of sodium citrate and potassium sodium tartrate.

3. The ink as claimed in claim 1, wherein the palladium salt is selected from the group consisting of palladium sulfate, palladium chloride, palladium nitrate and palladium-based complex.

4. The ink as claimed in claim 1, wherein a concentration of the reducing agent is in a range from 10⁻³ to 0.4 mol/L.

5. The ink as claimed in claim 1, wherein a concentration of the palladium salt is in a range from 10⁻⁴ to 1 mol/L.

6. The ink as claimed in claim 1, wherein a molar ratio of the reducing agent to the palladium salt is in a range from 10:1 to 200:1.

7. The ink as claimed in claim 1, further comprising ethylene glycol in an amount of less than or equal to 50 weight percent.

8. The ink as claimed in claim 1, wherein a molar ratio of the reducing agent to the palladium salt is in a range from 40:1 to 80:1.

9. The ink as claimed in claim 7, further comprising ethylene glycol in an amount of equal to 20 weight percent weight percent.

10. The ink as claimed in claim 1, further comprising a binder in a range from 0.1 to 20 weight percent, a viscosity modifier in a range from 0.1 to 50 weight percent, a humectant in a range from 0.1 to 50 weight percent, and a surface-active agent in a range from 0.1 to 5 weight percent.

11. A method for forming electrical traces comprising:
providing a substrate;
printing a circuit pattern using a palladium ions-containing ink on the substrate, the ink comprising
an aqueous carrier medium;
a palladium salt soluble in the aqueous carrier medium; and
a reducing agent for reducing the palladium ions into palladium particles under an irradiation ray;
irradiating the circuit pattern using the irradiation ray to reduce palladium ions in the ink into palladium particles to form a palladium particle circuit pattern; and
electroless-plating a metal overcoat layer on the palladium particle circuit pattern thereby obtaining electrical traces.

12. The method as claimed in claim 11, wherein the metal overcoat layer is a copper overcoat layer.

13. The method as claimed in claim 11, wherein the electroless-plating solution used in the electtroless-plating process contains copper sulfate, potassium sodium tartrate, ethylene diamine tetraacetic acid disodium salt, formaldehyde and methanol.

14. The method as claimed in claim 11, wherein the irradiation ray is an ultraviolet ray.

15. The method as claimed in claim 11, wherein the circuit pattern is irradiated for about 1 minute to about 20 minutes.
